(19) United States
(12) Patent Application Publication
(10) Pub. No.: US 2005/0169733 A1
(43) Pub. Date: Aug. 4, 2005

(54) Automated tube handler system

(76) Inventors: Alexander V. Drynkin, Walnut Creek, CA (US); David B. Miller, Orinda, CA (US)

Correspondence Address: RICHARD ESTY PETERSON, 1905 - D PALMETTO AVENUE, PACIFICA, CA, 94044, US

(21) Appl. No.: 10/767,811

(22) Filed: Jan. 29, 2004

(51) Int. Cl. B65F 3/02

(52) U.S. Cl. 414/404

(57) ABSTRACT

An automated tube handler system that combines a robotic tube handler with a controller board control unit for operating the displacement mechanism and tube sorting procedures in communication with a host computer that has a tube management program for user control of the tube handler system, the robotic tube handler having a frame-like bed tray that supports a plurality of standard tube racks arranged in an array and having a platform with a tube identification station, a parking holder for a limited number of tubes, and a shuttle holder for transport of a number of tubes to an adjacent robotic tube handler, the XYZ displacement mechanism having a tube pick for selectively removing a tube from any position in the tube rack array and placing the tube in any other position in the array or in one of the holders.

### BACKGROUND OF THE INVENTION

This invention relates to an automated tube handler system that includes a robotic tube handler and a controller. In the described embodiments, the robotic tube handler has a bed for orthoganal placement of a plurality of tube racks, particularly standard racks that hold an array of tubes, such as the SBS type 96 tuck racks.

The robotic tube handler has an XYZ displacement mechanism with a four prong tube picker. Although the capacity may be varied, the counter-top sized robotic tube handler described, has a twenty tray capacity in a four by five configuration for processing 1,920 tubes.

Modern experimental and applied medicine has required the use of “test” tube arrays for processing large numbers of discrete samples. Certain conventions and standards have been developed for efficient handling of sets of tubes in fixed size trays. A standard eight by twelve tray holds 96 densely packed tubes. This makes hand sorting difficult and tedious. To avoid errors robotic sorting would be preferred.

To aid in accountability of tube handling, 2D bar coding has enabled the marking of individual tubes. This has greatly improved the tracking of tubes and importantly has provided a device for checking the reliability of the tube handling process. Additionally, radio frequency identification tags (RFID) have become small enough to affix to the bottom of a sample tube. This medium provides an equivalent identification system to barcode marking for discrete identification of individual tubes.

The tube handler of the subject invention automates the transfer of tubes among tube locations, in the embodiments described, includes features such as a parking holder and an interhandler shuttle holder which adds to the transfer locations for tracking and positioning discrete tubes.

Tube sorting is controlled by a controller which in a convenient embodiment combines a general purpose computer with an electronics control unit on-board the tube handler. A tube manager software program coordinates the robotic controls with an accounting record that is maintained by a conventional applications program, for example, one that is Windows 2000/XP® based and Excel® compliant.

The preferred automated tube handler system includes an integrated barcode scanner that has at least one scanner unit for discretely identifying bar code marked tubes. The basic barcode identification system is enhanced by a full bed scanner that scans and identifies the racks and the array of tubes in the seated racks. In combination, the robotic sorting system and alternate barcode or RFID verification system allow for accurate logs of tube movement and location.

The robotic tube handler system of this invention provides an ideal solution for a wide variety of rack-based tube preparation applications including:
compound library management;
preparation of samples;
sorting of specific assays;
re-array processing;
2D tube scanning;
RFID tube detection.

These and other features of the automated tube handling system will become apparent upon consideration of the specification and claims of this application.

### SUMMARY OF THE INVENTION

The automated tube handler system of this invention combines a robotic tube handler with a programmable controller to allow a user to sort and exchange sample tubes contained in standard tube racks.

As a general purpose, bench-top tube handler system, the controller is preferably in the form of a modern personal computer linked to an on-board control unit that operates the electromechanical components of the robotic tube handler and communicates with the personal computer as the host computer in transferring operating commands and extracting data for processing.

A tube management program allows the user to generate a work list and maintain an event log and database for a variety of tasks that arise in the laboratory. Although, primarily useful in the field of medicine, the device has application in the chemical petroleum and mining industries, and in other environments where numerous sample tubes must be sorted, exchanged or inventoried.

As an improved feature over conventional tube handling devices, the preferred embodiments include a tube identification station which individual tubes can be automatically identified according to a visual or electronic tag.

The robotic tube handler has an XYZ transport mechanism that provides for discrete selection and removal of any one tube in an array of tube racks seated on a bed tray of the tube handler. The removed tube can be placed in any other vacant location in the array of tube racks. Alternately, the tube can be placed in a temporary parking holder or in a shuttle holder for transport to an auxiliary robotic tube handling device, for example, a second identical tube handler seated adjacent the primary tube handler.

These and other features of this invention are described in greater detail in the detailed description of preferred embodiments.

### BRIEF DESCRIPTION OF THE DRAWINGS

FIG. 1 is a perspective view of the tube handler system.

FIG. 2 is a perspective view of the tube handler with an array of tube racks.

FIG. 3 is an enlarged, side-elevational cross-sectional view of a part of the XYZ transport mechanism.

FIG. 4 is an exploded view of the pick head unit on the transport mechanism.

FIG. 5 is an enlarged side elevational view of an optional tube fill component.

FIG. 6 is an enlarged end perspective view of a sample tube with an identification tag.

FIG. 7 is a front-elevational view, partially in breakaway, of the tube handler of FIG. 1.

FIGS. 8A-8H are flow chart diagrams depicting select features of the tube manager software program for controlling operation of the tube handler.

### DETAILED DESCRIPTION OF THE PREFERRED EMBODIMENTS

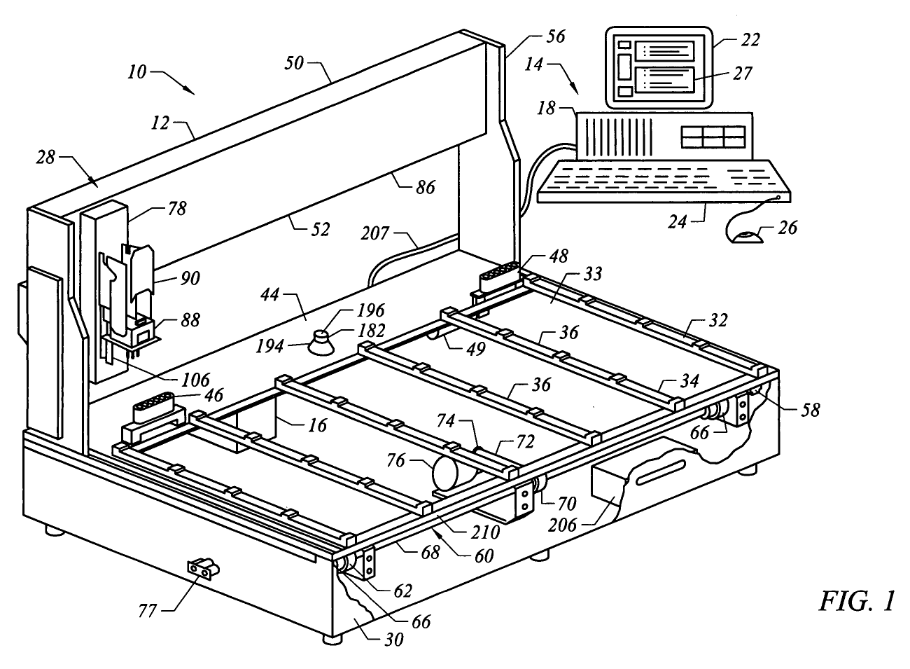

Referring to FIG. 1, the automated tube handler system is shown in FIG. 1 and is designated generally by the reference numeral 10. In the embodiment of FIG. 1, the automated tube handler system 10 includes a robotic tube handler 12 and a controller 14 which in part is comprised of an on-board control unit 16 in the tube handler 12 and a personal computer 18 connected to the robotic tube handler 12 by a communication cable 20 connected to the serial port of the computer 18.

The computer 18 includes a monitor 22, a keyboard 24 and a mouse 26 for controlling a tube manager software program with a screen display 27 that operates the system through user input. It is to be understood that other typical accessories can be connected to the computer such as a printer for hard copy reports, a modem for data communication and remote control, and other subsystems suitable to the environment of use.

The on-board control unit 16 in the embodiment shown has a controller card with an embedded control program for controlling the robotic XYZ transport mechanism and the data feeds that designate the location of a pickup mechanism 28 and transmit barcode data to the computer 18 for processing. Alternately, the control unit can include a display, an input device, such as a keypad and an output means, such as a disk burner for logging and recording tube management events.

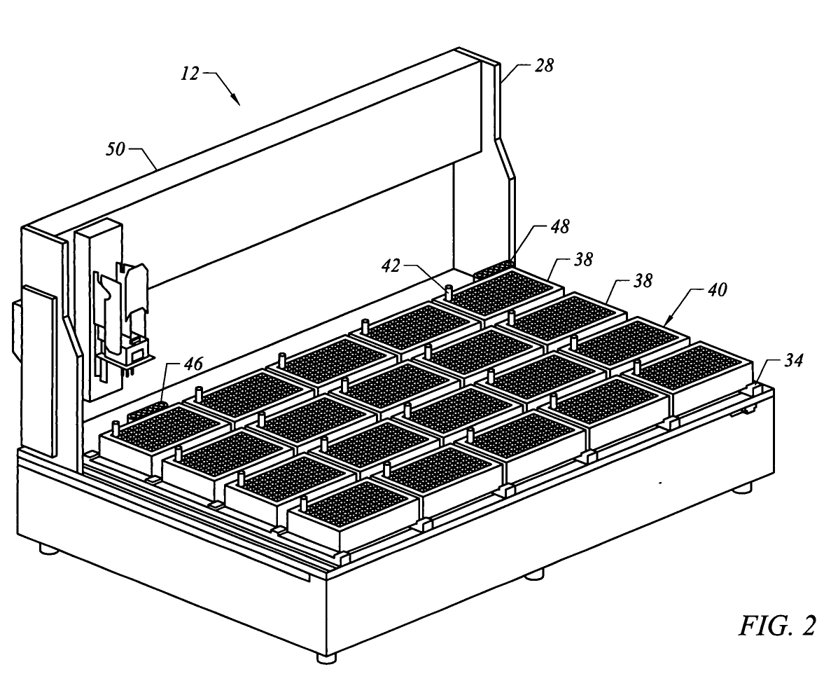

As shown in FIG. 1 a generally rectangular housing 30 provides a perimeter frame 32 for a bed 33 having a removable or installed open bed tray 34 (shown in FIG. 1 without the plate scanner). The bed tray 34 has a series of parallel support rails 36 for seating standard tube racks 38 in a predefined array 40 as shown in FIG. 2. The racks 28 in FIG. 2 show a single tube 42 in each rack 38.

The housing 30 also includes a rear platform 44 having a small parking holder 46 for temporary placement of a limited number of tubes when sorting, and a shuttle holder 48 with an actuator 49 for shuttling a limited number of tubes 42 from one robotic tube handler 12 to an adjacently placed robotic tube handler (not shown).

The pickup mechanism 28 is constructed with a crossbar transport unit 50 having a cross beam 52 connected to two post supports 56 spanning the bed 33. The post supports 56 engage tracks 58 mounted to the sides of the housing 30.

The cross bar transport unit 50 traverses fore and aft over the bed 33 by a belt assembly 60 having fore and aft belt gears 62 and 64 with belts 66. The fore belt gears 62 have a common support shaft 68 as shown in the breakaway of FIG. 1. As central gear 70 on the shaft 68 has a short belt 72 connected to the drive gear 74 of a precision stepping motor 76.

The track mounted post supports 56 are connected to the belts 66 and are displaced fore and aft under control of the precision motor 76. An appropriate center switch 77 limits the displacement to the useable field over the bed 33 by identifying the center position for the crossbar transport unit 50.

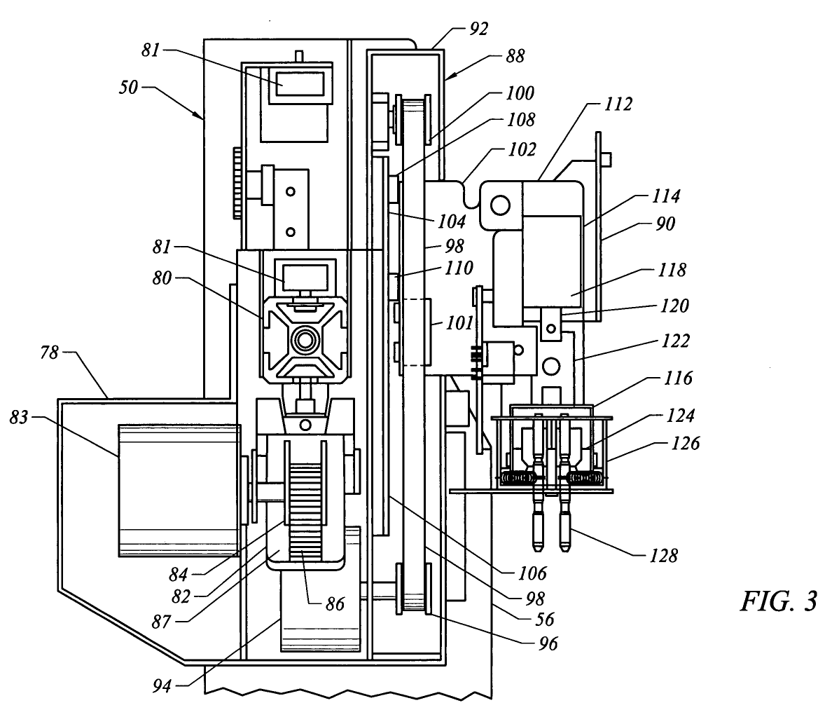

As shown in the enlarged cross sectional view of FIG. 3, the cross beam 52 on the transport unit 50 supports an elevator carriage 78 on a track 80 with guides 81 over the bed 33. A belt mechanism 82 transports the elevator carriage 78 in a side to side manner over the bed 33. The elevator carriage 78 has a precision stepping motor 83 with a drive gear 84 that engages a stationary transport belt 86 with a wrapping guide 87 under the cross beam track 80 enabling the elevator carriage 78 to track side to side under control of the stepping motor 82.

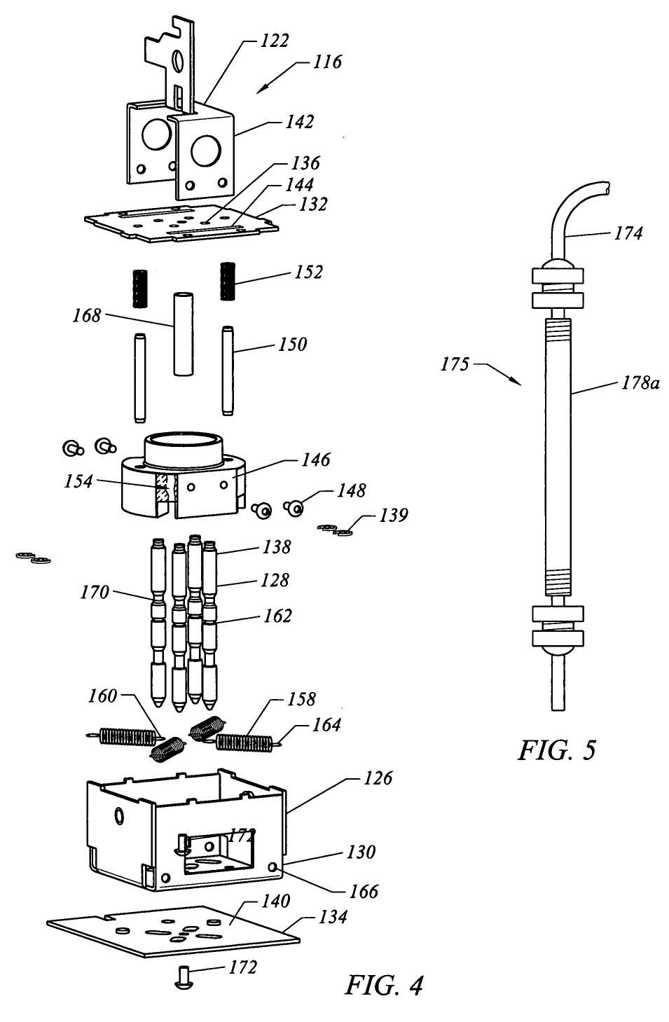

The elevator carriage 78 carries the elevator assembly 88 for the pick head unit 90. As shown in the enlarged side views of FIG. 3 and the exploded view of FIG. 4, the elevator assembly 88 has a vertical transport housing 92 with a precision stepping motor 94 mounted on the housing 92. The stepping motor 94 has a drive gear 96 in the housing that engages a continuous belt 98 that wraps around an idler gear 100. The belt 98 is connected with a connector 101 to a guide bracket 102 on the pick head unit 90 under control of the stepping motor 94. The guide bracket 102 has a guide 104 that engages a slide track 106 on the transport housing 92 for accurate positioning of the vertically displaceable pick head unit 90. Displacement is limited by limit sensors 108 and 110. The pick head unit 90 is easily removable for inspection and cleaning, or for replacement with a conventional tube fill unit.

The pick head unit 90 has a support structure 112 that supports a solenoid actuator 114 above a pick head 116. The solenoid actuator 114 has a solenoid coil 118 and an armature 120 that is connected to a lift bracket 122 which in turn is connected to a cam ring 124 contained within a housing 126 of the pick head 116.

Referring in addition to the exploded view of FIG. 4, the pick head 116 has four slender, pick fingers 128 which are actuated to an open or spread position upon activation of the solenoid actuator 114. The housing 126 has a casing 130 with a top cover 132 and a bottom cover 134. The top cover 132 has four slightly oversized socket holes 136 in which the upper ends 138 of the pick fingers 128 are seated for limited pivot and held by c-clips 139. The bottom cover 134 has four corresponding radial slots 140 through which the pick fingers 128 project, allowing limited articulation.

The lift bracket 122 has a pair of end plates 142 that extend through slots 144 in the top cover 132 and connect to surface flats 146 on the outside of the cam ring 124 by screws 148. The cam ring 124 slides on spacer pins 150 which carry compression springs 152 to bias the cam ring 124 in the downward position. The cam ring 124 has an inner cam ridge 154 which engages a portion of the outer cylindrical surface 156 of each pick finger 128 when the solenoid actuator 114 is in its deactivated state. In this position the pick fingers 128 are contracted against the bias of four tension springs 158 each having one end 160 encircling a locating groove 162 in the fingers 128 and the other end 164 hooked through corner holes 166 in the casing 130. When the solenoid armature is retracted the cam ring 124 is raised and the cam ridge 154 is positioned at a constricted segment 170 of each pick finger 128, thereby spreading the four pick fingers 128. A center shaft 168 with end screws 172 (one shown) keeps the covers 132 and 134 together.

It is to be understood that the tube handler system of this invention can be easily adapted to a tube filler by removal of the pick head unit 90 and replacement with a conventional tube-fill unit. The operation of the tube handler with the tube-Fill unit is similar to the operation with the pick head unit 90. Alternately, a tube-Fill unit 1775 can comprise an integrated tube filler 174 in the form of a fill cannular 176 as shown in the enlarged, partially exploded view of FIG. 5 can be fitted to a modified tubular center shaft 178a for a combination fill and pick unit 174.

In addition to the mechanics for a robotic tube handler 12, the embodiment of FIG. 1 includes a verification subsystem to selectively identify tube racks and individual tubes.

Behind the bed tray 34 on which the 4×5 array of tube racks 38 is carried is a platform 44 having a centrally positioned identification station 182. The identification station 182 verifies the identity of a discrete tube 42 by examining its tag 184, which for example is a combination visual and electronic code label 186.

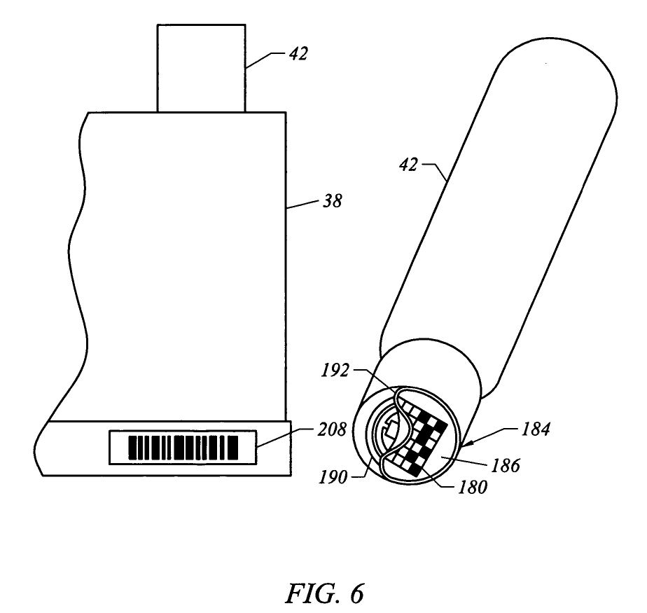

The code label 186 preferably has a 2D barcode marking 188 and a thin film, radio frequency emitter 190 combined in peel-off label 192 as shown in the enlarge view of FIG. 6. Although either form of identification method can be used without the other, the tube handler 12 can be optionally equipped to handle both in combined ID sensors 193.

In FIG. 1, the raised bezel 194 holds a center lens 196 for a CCD camera 198 that captures records and transmits for interpretation a visual symbol or marking 200 on the bottom of each tube 42. The marking 200 is preferably a standard 2D “data matrix” type barcode.

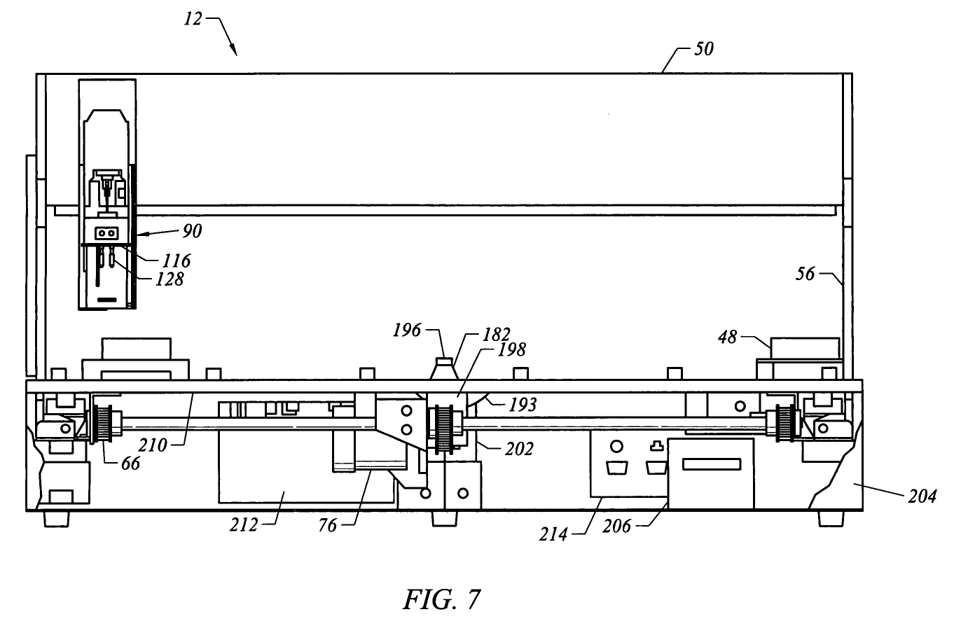

As shown in the front cut-away view of FIG. 7, in addition to the CCD camera 198, the identification station 182 includes an annular radio frequency receiver 202 that receives RFID code signals to electronically identify a particular tube. The receiver 202 can be a conventional reader, such as a 915 MHz RFID reader and compatible tags. The robotic system selects and positions a tube 42 in close proximity to the ID sensors 193 in the ID station 182. Because of the close proximity, the radio frequency receiver 202 can include a signal emitter to project a signal to charge and activate the micro emitter 190 in the code label 186 to transmit the code ID for the labeled tube 42.

The center lens 196 of the CCD camera 198 is also useful as a geographic marker to set the position of the pick head 116 or the tube-fill unit 175, if the pick head unit 190 is replaced with a tube-fill unit. The four slender fingers 128 of the pick head 116, which are orthogonally aligned to the four spaces between densely packed tubes, must be precisely registered in order to project down alongside a selected tube without disturbing adjacent tubes. This is accomplished by a feed-back pattern matching routine for centering the four pick head fingers 128 over the lens 196. Other mappings are coordinated to this convenient artifact.

In addition, the front panel 204 of the rectangular housing 30 includes a barcode scanner 206, for example, a linear scanner having a downwardly sweeping scanner beam to detect a linear barcode label 208 on individual racks to identify the rack when placed into the seated bed tray 34. Since tube racks 38 designed for bottom marked tubes have substantially open bottoms, the tube handler system 10 includes a thin plate scanner 210 arranged under the bed tray 34 for a full scan of the arrayed tubes for logging and analysis, if desired.

Alternately, the use of a removable bed tray 34 enables the bottoms of the entire twenty rack inventory to be removed and scanned on an auxiliary scanner.

In order to control operations, log data and enable report generation, the controller 14 operates with the tube manager software program. In the described embodiment, the on-board control unit 16 has an electronic controller card 212 that manages the electromechanical control operations for the tube handler 12 pursuant to digital command signals from the interactive personal computer 18.

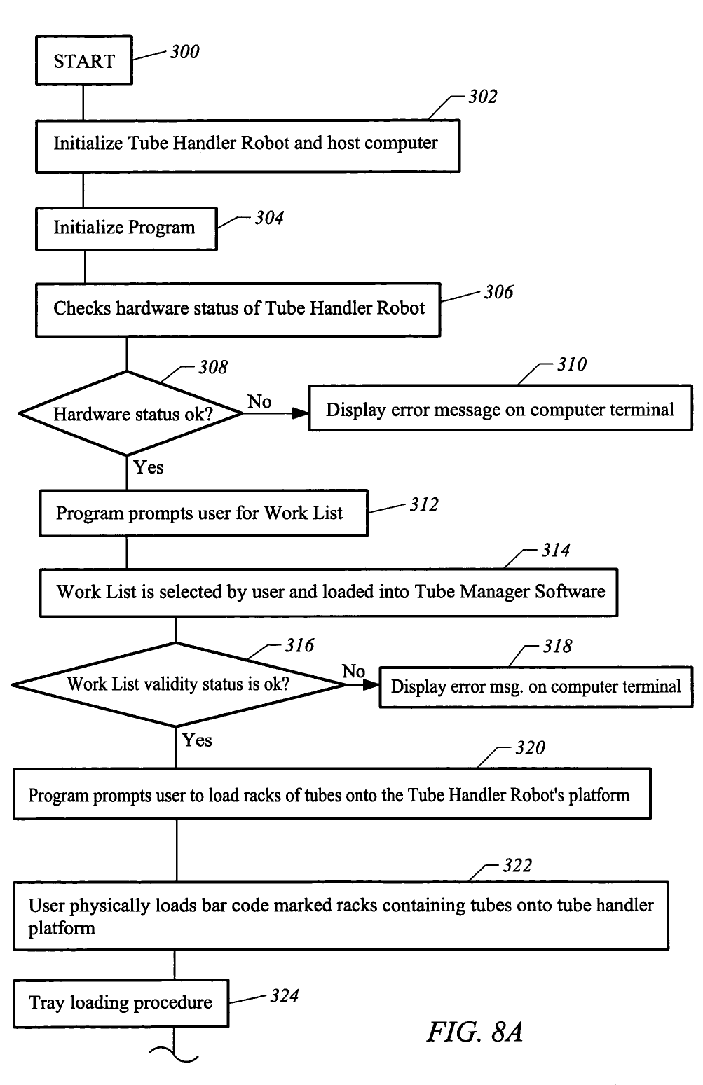

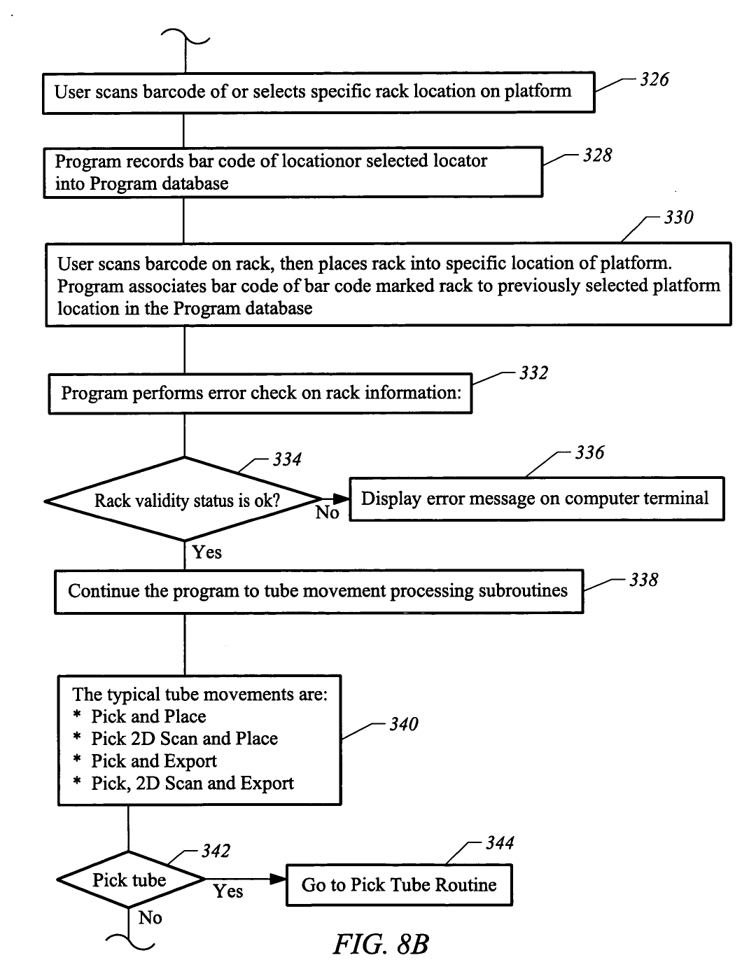

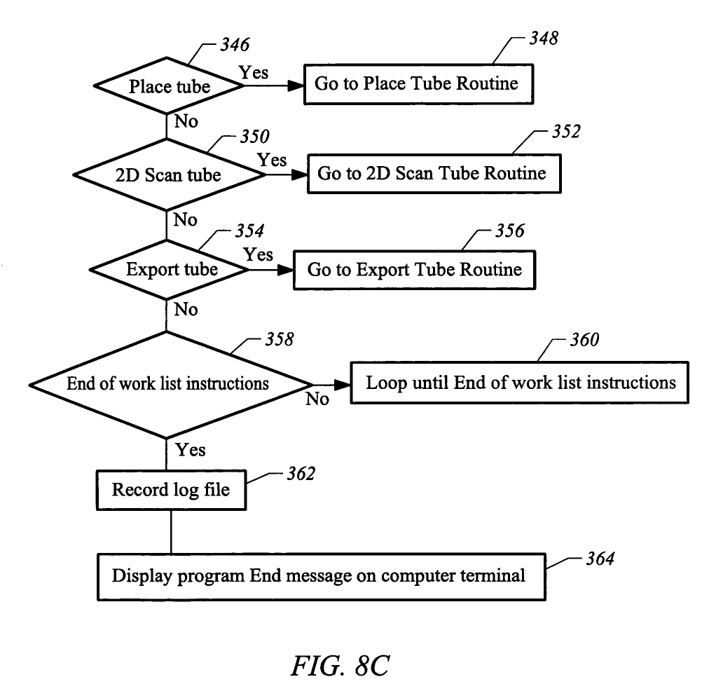

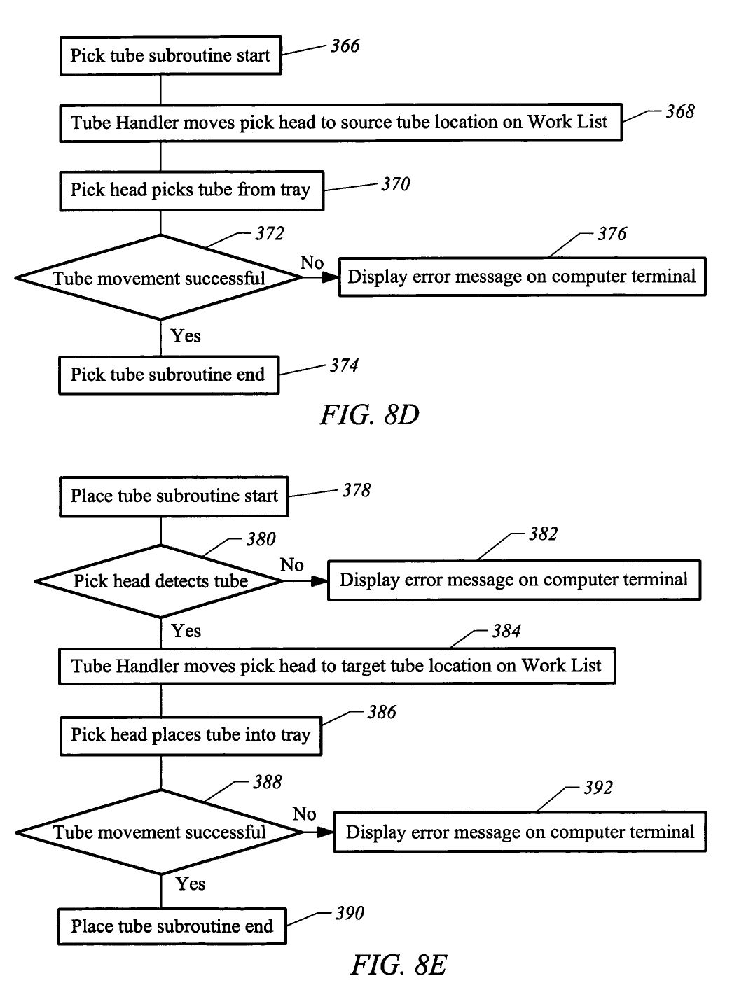

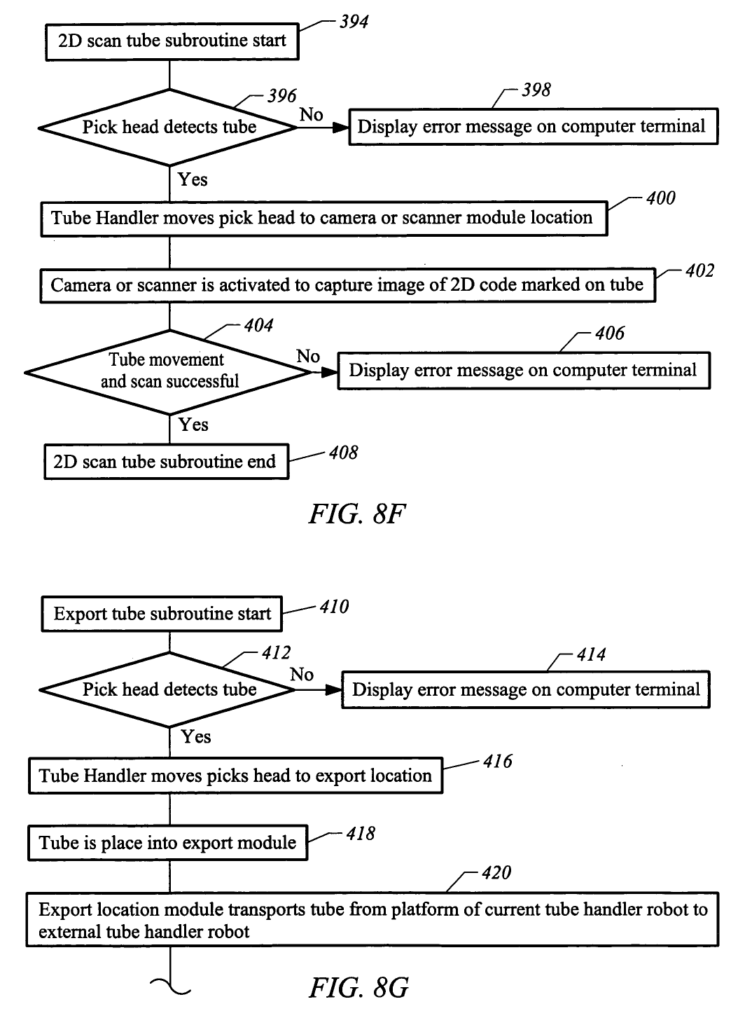

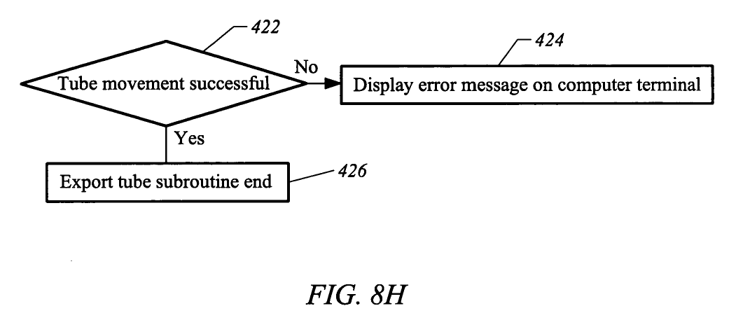

In addition, the serial port 214 returns data including position data from the stepping motors image files from the camera 198, RFID files from the receiver 202, and image files from an on-board or auxiliary scanner. Processing the data and presenting a convenient user interface is accomplished by the computer 18. The basic tube handling procedures are shown in the block diagram of FIGS. 8A-8H.

Referring to FIG. 8A, the procedure as outlined in the flow chart begins with a powerup start at box 300. This causes the initialization of the robotic tube handler 12 and host computer 18 at box 302. Following the initializing of the tube management program at box 304, the hardware status is checked using an appropriate subroutine at box 306. At decision diamond 308 the result, if unfavorable, generates an error message at box 310. If the status is OK, the program prompts the user for a work list at box 371.

In general the available work routines are catalogued and presented to a user for selection using the friendly user interface with familiar templates that are in accord with the features of the particular tube handler device being utilized. The selected work list is loaded into the active tube management program at box 314 and its validity is checked at diamond 316. If invalid, for example, commanding an RFID reading for a tube handler having only a barcode reader, then an error message is displayed at box 318.

If valid, then the program prompts the user to load racks of tubes onto the tube handler platform, here the bed tray 34 at box 320. This presumes that the user is starting with an unloaded bed and is not picking up from a previous tube handling session. After the user prompt at box 320 the user loads the tube racks at box 322 following the subroutine starting at box 324.

As continued on FIG. 8B, before placing the tube rack onto the platform, the user selects the location by scanning the location barcode with a portable scanner at box 326 for storage a database at box 328. The user then scans the barcode on the rack at box 230, a cross reference the location and rack identification occurs at box 330. Alternately, the tube rack is scanned by the tube handler scanner 206 and the user selects the location from a screen template on the monitor to cross reference the rack and location for logging into a database at box 330.

Typically, information about the tube rack, and contained tubes is pre-existing and is imported into the management program for further processing.

At box 332, the program performs an error check on rack information. In addition to verifying a valid rack I.D., the routing may check against imported information to verify the correct racks are being loaded. A decision diamond 334, if invalid an error message is generated at box 336. If valid, then proceed to tube movement subroutines at box 338.

It is to be understood that if the entire filled bed tray 34 is loaded at once onto the tube handler, the cross-referenced data relating to the rack identification and tray location may be pre-generated and simply imported into the management program.

The typical tube movement subroutines are listed in oval 340 and processed in decision diamonds 342 and invoked routines 344 in FIG. 8B; and decision diamonds 346, 350 and 354 and invoked routines 348, 352 and 356 in FIG. 8C. If work routines are apparently completed or not invoked, the process proceeds to decision diamond 358 where end is validated or if not loop continued at box 360. If, yes, the log file is recorded at box 362 and an end message is displayed on the screen at box 364.

The flow charts for the subroutines are depicted in FIG. 8D to FIG. 8H.

In FIG. 8D, the pick tube subroutine starts at box 366 causing the tube handler mechanism to move to the desired position in box 368 with the pick function performed at box 370. Decision diamond 372 reports success at routine end box 374 or fail at error message box 376.

In FIG. 8E, the place tube subroutine starts at box 378 with decision diamond 380 determining if a tube is in pick with a no generating an error message at box 382 and yes proceeding to drop location at box 384 with a drop at box 386. Again, at decision diamond 388 success is signaled with subroutine end at box 390 and failure with error message at box 392.

In FIG. 8F, the scan tube routine starts at box 394 with a decision 396 to determine if pick holds a tube. If no an error message is generated at box 398, and if yes, the pick head moves to the I.D. station 182, here the 2D camera 198 at box 400. The subroutine is similar for an RFID system. The scanner is actuated at box 402 for image capture. At decision diamond 404, if the scan was not successful an error message is generated at box 406. If successful, the scan is logged, and in a preferred routine, an image is captured with interpreted ID, as a cross check at the routine end at box 408.

In FIG. 8G, the export tube subroutine starts at box 410 and proceeds to decision diamond 412 where the pick checks for a held tube. If no, error message is generated at box 414, and if yes, the tube handler transports the tube to the export location at box 410. The tube is placed in the export module at box 418 which may be the parking holder 46 for manual removal, or, the shuttle holder 48 for robotic removal, for example, by a second adjacent tube handler 12. If the latter, in box 420, the shuttle is activated for external robotic pickup.

In FIG. 8H, the routine of FIG. 8G continues with a decision diamond 422 to determine a successful movement. If no, error message is generated in box 424 and if yes, export subroutine ends in box 426. The subroutine may require an acknowledgment from the adjacent device before retracting the shuttle holder 48 and ending the routine.

While, in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

1. An automated tube handler system comprising:
a tube handler having:
an XYZ head transport mechanism with a pick having a four pick fingers.
a bed tray having a support structure that supports a plurality of tube racks in an array:
a controller having a tube management program wherein tubes from any one location in an array of tube racks can be removed by the pick head and placed in any other vacant location in the array of tube racks.
